(19) United States
(12) Patent Application Publication
(10) Pub. No.: US 2017/0058180 A1
(43) Pub. Date: Mar. 2, 2017

(54) ENVIRONMENTALLY SAFE FILTRATION CONTROL AGENTS FOR DRILLING FLUIDS

(71) Applicant: KING FAHD UNIVERSITY OF PETROLEUM AND MINERALS, Dhahran (SA)

(72) Inventors: M. ENAMUL HOSSAIN, DHAHRAN (SA); MOHAMMED WAJHEEUDDIN, DAMMAM (SA)

(21) Appl. No.: 14/842,420

(22) Filed: Sep. 1, 2015

(51) Int. Cl. C09K 8/20

(52) U.S. Cl. CPC C09K 8/206

(57) ABSTRACT

The environmentally safe filtration control agent for drilling fluids is an additive for aqueous drilling fluids to reduce the loss of fluids from the mud cake to the pores of the formation during the drilling of oil and gas wells. The additive may be powdered grass formed by drying grass and grinding the dried grass to micron-sized particles; date seed powder formed by grinding the seeds of date plants to micron-sized particles; or grass ash powder formed by dried grass burnt in a furnace and ground to micron-sized particles. The filtration control agent is generally present in the drilling fluid as a concentration between 0.25 ppb and 2 ppb, optimally between 1.0 ppb and 2.0 ppb, depending on the agent. An exemplary drilling fluid includes water, bentonite, and the fluid control agent.

### BACKGROUND OF THE INVENTION

1. Field of the Invention

The present invention relates to drilling fluids, and particularly to environmentally safe filtration control agents for drilling fluids.

2. Description of the Related Art

Fluids are used during oil well and natural gas well drilling operations for various purposes. During the drilling of wells for oil and gas, drilling fluids (also known as drilling muds) are circulated in such a manner that they serve to remove cuttings, lubricate the drilling tool, maintain a hydrostatic pressure in the bore hole during drilling, seal off unwanted formations that hinder production from the drilled well, etc. The drilling fluids usually contain additives to impart desirable properties to the mud for a smooth drilling operation to take place. The additives present in the mud form a thin, low permeability filter on the sides of the borehole to control the filtration characteristics of the drilling fluid. Liquid that enters the formation while the filter layer is being established (referred to as surge or spurt loss) and liquid that enters after the filter layer is formed (known as drilling fluid filtrate) are both undesirable, and need to be taken care of by quick buildup of a firm filter cake (or mud cake) that seals openings in formations to reduce the unwanted influx of fluids or the loss of drilling fluids to permeable formations. The drilling fluid must circulate in the wellbore (down the drill pipe and back up the annulus) to perform the above-mentioned functions.

Fluid loss is a common occurrence in drilling operations and may lead to undesirable phenomena, such as (1) poor circulation and less efficient removal of cuttings; (2) damaging the well bore region by the invasion of drilling fluid into the formation; (3) additional cost in rig time, manpower, and material to replenish and restore circulation as a result of (1) or (2); and (4) in extreme cases, insufficient downhole hydrostatic pressure, which may lead to a blowout. In the event such phenomena occur, the normal procedure is to add fluid loss agents to the drilling fluid.

Drilling fluids may be oil-based or water-based. Oil-based drilling fluids tend to be more environmentally toxic than water-based drilling fluids. Many drilling operations rely on polymer additives as a filtration control agent in water-based drilling fluids. However, such polymers are frequently accompanied by problems with the viscosity of the fluid, such as slow drilling rate, excessive drill pipe torque and drag, differential sticking, etc. Thus, careful attention to the rheological properties of the additives and the resulting drilling fluid is necessary.

While several “green” additives for drilling fluids have been proposed, none have proved entirely satisfactory. Thus, environmentally safe filtration control agents for drilling fluids solving the aforementioned problems are desired.

### SUMMARY OF THE INVENTION

The environmentally safe filtration control agent for drilling fluids is an additive for aqueous drilling fluids to reduce the loss of fluids from the mud cake to the pores of the formation during the drilling of oil and gas wells. The additive may be powdered grass formed by drying grass and grinding the dried grass to micron-sized particles; date seed powder formed by grinding the seeds of date plants to micron-sized particles; or grass ash powder formed by dried grass burnt in a furnace and ground to micron-sized particles. The filtration control agent is generally present in the drilling fluid as a concentration between 0.25 ppb and 2 ppb, optimally between 1.0 ppb and 2.0 ppb, depending on the agent. An exemplary drilling fluid includes water, bentonite, and the fluid control agent.

These and other features of the present invention will become readily apparent upon further review of the following specification and drawings.

### BRIEF DESCRIPTION OF THE DRAWINGS

FIG. 1 is the XRF spectrum of a first embodiment of an environmentally safe filtration control agent for drilling fluids, comprising powdered grass.

FIG. 2 is the XRF spectrum of a second embodiment of an environmentally safe filtration control agent for drilling fluids, comprising date seed powder.

FIG. 3 is the XRF spectrum of a third embodiment of an environmentally safe filtration control agent for drilling fluids, comprising grass ash powder.

Similar reference characters denote corresponding features consistently throughout the attached drawings.

### DETAILED DESCRIPTION OF THE PREFERRED EMBODIMENTS

The environmentally safe filtration control agents for drilling fluids may use powdered grass, date seed powder, or grass ash powder as an additive.

During the drilling of wells for oil and gas, drilling fluids (drilling muds) are circulated so that the fluids remove cuttings, lubricate the drilling tool, maintain hydrostatic pressure in the borehole during drilling, seal off unwanted formations that hinder production from the drilled well etc. These drilling fluids include various additives that impart desirable properties to the mud for a smooth drilling operation to take place. The additives present in the mud form a thin, low permeability filter of some form, which is desired on the sides of the borehole to control the filtration characteristic of the drilling fluid. The liquid which enters the formation while the filter layer is being established is known as surge or spurt loss, whereas the liquid that enters after the filter layer is formed is known as the drilling fluid filtrate. Both filtrations are undesirable and need to be taken care of by the quick buildup of a firm filter cake.

As stated, fluid loss is a common occurrence in drilling operations and may lead to undesirable phenomena such as: (1) poor circulation and less efficient removal of cuttings; (2) damaging the near wellbore region by the invasion of drilling fluid into the formation; (3) requiring additional cost in rig time, manpower and material to replenish and restore circulation; and in extreme cases, (4) leading to insufficient downhole hydrostatic pressure, which may lead to a blowout. Curing losses effectively and quickly is still a matter of concern from many companies and operators. Under these conditions, the normal procedure is to add fluid loss agents, which alone may decrease the losses while drilling to an acceptable level.

In a first embodiment, the environmentally safe filtration control agent for drilling fluids comprises powdered grass. X-ray fluorescence (XRF) analysis was conducted on the powdered grass sample, which revealed the elemental composition shown in Table 1.

TABLE 1
XRF Results

| Element | Atomic Number | Net Normal weight % |
|---|---|---|
| Calcium (Ca) | 20 | 53.80 |
| Potassium (K) | 19 | 19.83 |
| Chlorine (Cl) | 17 | 15.54 |
| Sulfur (S) | 16 | 3.89 |
| Silicon (Si) | 14 | 3.13 |
| Iron (Fe) | 26 | 2.46 |
| Phosphorous (P) | 15 | 1.24 |
| Manganese (MN) | 25 | 0.12 |

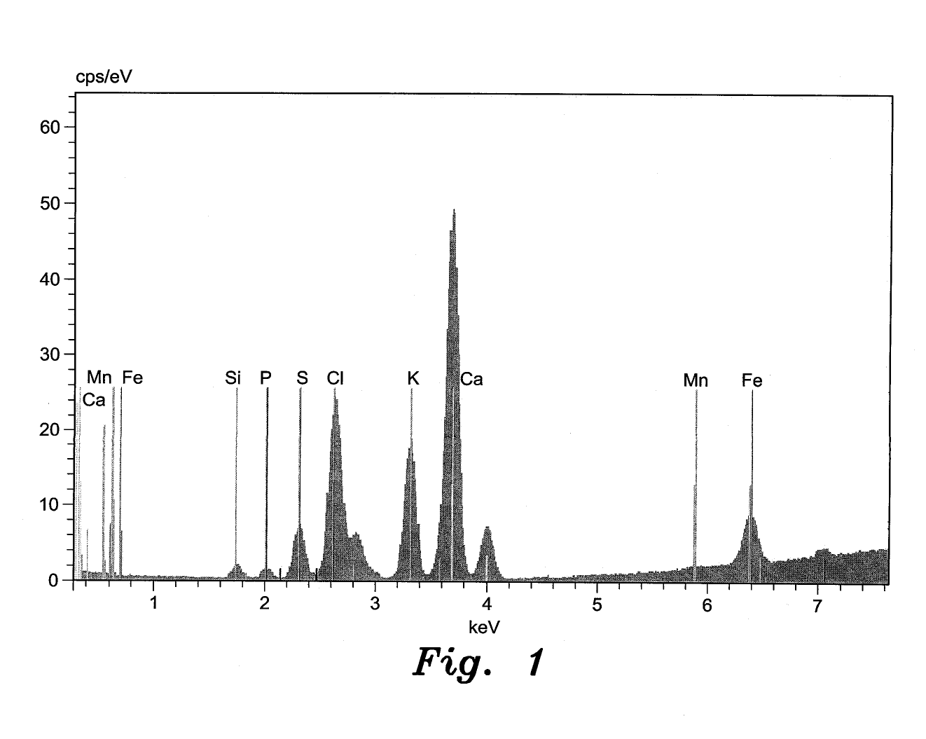

The XRF analysis showed that the grass sample consists of calcium, potassium, chlorine, sulfur, silicon, iron, phosphorous and manganese, with calcium contributing the highest weight percent to the sample. The graphical result of the XRF is shown in FIG. 1. The use of powdered grass as a filtration control agent for drilling fluids is illustrated by the following examples.

### Example 1

### Sample Preparation—Grass Powder

Grass was dried in a sunny area for a week and then ground in a grinding machine. The powdered material was then passed through a series of U.S. Standard Series sieves of the fine series having a particle range in proportions shown in Table 2.

TABLE 2
Particle Size Distribution of Grass Sample

| Mesh | Sieve Size Opening | Percent Weight Retained |
|---|---|---|
| Number | (μ) | (%) |
| 50 | 300 | 13.25 |
| 80 | 180 | 41.87 |
| 120 | 125 | 21.08 |
| 170 | 90 | 7.78 |
| 200 | 75 | 9.63 |
| Over 200 | >75 | 6.05 |

A base mud is prepared using a commercially available viscosifier, bentonite. Bentonite is added to water under high speed stirring and different weights of powdered grass corresponding to different sieve sizes will be added to this mixture. The rheological properties density, viscosity, filtration loss, pH concentration etc. of this newly developed drilling mud is then studied. Owing to the particle sizes selected, the inventors are of the opinion that powdered grass could be used as a fluid loss control additive and could be a potential replacement for toxic chemicals used in the oil industry.

### Example 2

### Characterization of Grass Powder—300 Micron Particle Size

This series of experiments is conducted on powdered grass having a particle size of 300 microns. It is evident from Table 3 that as the concentration of grass powder in the drilling fluid increases, the rheology is modified. The apparent viscosity, plastic viscosity and yield point increases. The gel strength at 10 minutes is altered, gaining a maximum value of 16 lb/100 ft² at 1.0 ppb concentration. A good gel strength value indicates that the mud has cuttings carrying capacity. Thus, grass can be used as a rheological modifier for drilling fluid applications.

TABLE 3
Rheological parameters at 300 micron particle size - grass powder

| | Dial Reading, | | | | |
|---|---|---|---|---|---|
| Speed, | 0 ppb (only | | | | |
| rpm | Bentonite) | 0.25 ppb | 0.5 ppb | 0.75 ppb | 1 ppb |
| 600 | 20 | 21 | 21 | 21.5 | 22 |
| 300 | 12 | 12.5 | 12.5 | 13 | 13.5 |
| 200 | 9 | 9.5 | 10 | 10.5 | 11 |
| 100 | 6 | 6.5 | 7 | 7 | 7 |
| 6 | 1.5 | 1.5 | 2 | 2.5 | 2.5 |
| 3 | 1 | 1.5 | 1.5 | 2 | 2 |
| AV, cp | 10 | 10.5 | 10.5 | 10.75 | 11 |
| PV, cp | 8 | 8.5 | 8.5 | 8.5 | 8.5 |
| YP, | 4 | 4 | 4 | 4.5 | 5 |
| lb/100 ft² | | | | | |
| GS 10 sec, | 1 | 1.5 | 2 | 2.5 | 3 |
| lb/100 ft² | | | | | |
| GS 10 min, | 10 | 15 | 15 | 15 | 16 |
| lb/100 ft² | | | | | |

Table 4 shows the filtration characteristics of the mud with increasing grass concentration. It is observed that as the concentration is increased, the filtration properties of the muds are improved and the percentage water reduction achieved is about 25% at 1.0 ppb concentration. Making filtration as the basis for optimization, it is recommended that 1.0 ppb be the best optimum concentration, Thus, it can be stated that powdered grass can be used as a filtration control agent for drilling fluids.

TABLE 4
Filtration characteristics at 300 micron particle size - Grass powder

| t, | ml of Filtrate collected | | | | |
|---|---|---|---|---|---|
| min | 0 ppb | 0.25 ppb | 0.5 ppb | 0.75 ppb | 1.0 ppb |
| 5 | 5.6 | 5 | 4 | 4 | 3.9 |
| 10 | 8.6 | 7.5 | 6.3 | 6.1 | 6 |
| 15 | 10.4 | 9.3 | 8 | 7.8 | 7.6 |
| 20 | 12.1 | 11 | 9.4 | 9.1 | 9 |
| 25 | 13.6 | 12.3 | 10.7 | 10.4 | 10.2 |
| 30 | 15 | 13.6 | 11.9 | 11.5 | 11.3 |

| | | | | |
|---|---|---|---|---|
| % Reduction in | 9.33333 | 20.67 | 23.33 | 24.67 |
| Water Loss | | | | |

From Table 5, it is seen that the addition of grass into the drilling mud decreases the pH of the mud. This is another applicability of grass powder to perform as an alkalinity control agent for drilling fluids.

TABLE 5
pH of the mud at 300 microns

| Mud | 0 ppb | 0.25 ppb | 0.5 ppb | 0.75 ppb | 1.0 ppb |
|---|---|---|---|---|---|
| pH | 8.5 | 8.35 | 8.07 | 7.94 | 7.82 |

### Example 3

### Characterization of Grass Powder—90 Micron Particle Size

This series of experiments is conducted on powdered grass having a particle size of 90 microns. It is evident from Table 6 that as the concentration of grass powder in the drilling fluid increases, the rheology is modified. The apparent viscosity, plastic viscosity and yield point increases. The gel strength at 10 minutes is altered, gaining a maximum value of 16 lb/100 ft² at 1.0 ppb concentration. A good gel strength value indicates that the mud has cuttings carrying capacity. Thus, grass powder can be used as a rheological modifier for drilling fluid applications.

TABLE 6
Rheological parameters at 90 micron particle size

| | Dial Reading, | | | | |
|---|---|---|---|---|---|
| Speed, | 0 ppb (only | | | | |
| rpm | Bentonite) | 0.25 ppb | 0.5 ppb | 0.75 ppb | 1 ppb |
| 600 | 20 | 20.5 | 20.5 | 21 | 21.5 |
| 300 | 12 | 12.5 | 12.5 | 12.5 | 13 |
| 200 | 9 | 10 | 10 | 10 | 10 |
| 100 | 6 | 6.5 | 6.5 | 7 | 7.5 |
| 6 | 1.5 | 1.5 | 1.5 | 2 | 2 |
| 3 | 1 | 1.5 | 1.5 | 1.5 | 1.5 |
| AV, cp | 10 | 10.25 | 10.25 | 10.5 | 10.75 |
| PV, cp | 8 | 8 | 8 | 8.5 | 8.5 |
| YP, | 4 | 4.5 | 4.5 | 4 | 4.5 |
| lb/100 ft² | | | | | |
| GS 10 sec, | 1 | 1.5 | 2 | 3 | 3 |
| lb/100 ft² | | | | | |
| GS 10 min, | 10 | 14 | 14 | 15 | 16 |
| lb/100 ft² | | | | | |

Table 7 shows the filtration characteristics of the mud with increasing grass concentration. It is observed that as the concentration is increased, the filtration properties of the muds are improved and the percentage water reduction achieved is 23% at 1.0 ppb concentration. Making filtration as the basis for optimization, it is recommended that 1.0 ppb be the best optimum concentration. Thus, it can be stated that powdered grass can be used as a filtration control agent for drilling fluids.

TABLE 7
Filtration characteristics at 90 micron particle size

| t, | ml of Filtrate collected | | | | |
|---|---|---|---|---|---|
| min | 0 ppb | 0.25 ppb | 0.5 ppb | 0.75 ppb | 1.0 ppb |
| 5 | 5.6 | 5 | 4.8 | 4 | 3.9 |
| 10 | 8.6 | 7.9 | 7.8 | 6.2 | 6.2 |
| 15 | 10.4 | 9.9 | 9.8 | 7.9 | 7.8 |
| 20 | 12.1 | 11.5 | 11.4 | 9.4 | 9.2 |
| 25 | 13.6 | 12.9 | 12.8 | 10.7 | 10.4 |
| 30 | 15 | 14.2 | 14 | 11.8 | 11.5 |

| | | | | |
|---|---|---|---|---|
| % Reduction in | 5.33 | 6.67 | 21.33 | 23.33 |
| Water Loss | | | | |

From Table 8, it is seen that the addition of grass into the drilling mud decreases the pH of the mud. This is another applicability of grass powder to perform as an alkalinity control agent for drilling fluids.

TABLE 8
pH of the mud at 90 microns

| Mud | 0 ppb | 0.25 ppb | 0.5 ppb | 0.75 ppb | 1.0 ppb |
|---|---|---|---|---|---|
| pH | 8.5 | 8.17 | 8.1 | 8.04 | 7.97 |

### Example 4

### Characterization of Grass Powder—35 Micron Particle Size

This series of experiments is conducted on powdered grass having a particle size of 35 microns. It is evident from Table 9 that as the concentration of grass powder in the drilling fluid increases, the rheology is modified. The apparent viscosity, plastic viscosity and yield point increases. The gel strength at 10 minutes is altered, gaining a maximum value of 17 lb/100 ft² at 1.0 ppb concentration. A good gel strength value indicates that the mud has cuttings carrying capacity. Thus, grass can be used as a rheological modifier for drilling fluid applications.

TABLE 9
Rheological parameters at 35 micron particle size

| | Dial Reading, | | | | |
|---|---|---|---|---|---|
| Speed, | 0 ppb (only | | | | |
| rpm | Bentonite) | 0.25 ppb | 0.5 ppb | 0.75 ppb | 1 ppb |
| 600 | 20 | 20.5 | 21 | 21.5 | 22.5 |
| 300 | 12 | 12 | 12.5 | 13 | 13.5 |
| 200 | 9 | 9 | 9.5 | 9.5 | 10 |
| 100 | 6 | 6.5 | 7 | 7.5 | 7.5 |
| 6 | 1.5 | 1.5 | 1.5 | 2 | 2 |
| 3 | 1 | 1.5 | 1.5 | 1.5 | 1.5 |
| AV, cp | 10 | 10.25 | 10.5 | 10.75 | 11.25 |
| PV, cp | 8 | 8.5 | 8.5 | 8.5 | 9 |
| YP, | 4 | 3.5 | 4 | 4.5 | 4.5 |
| lb/100 ft² | | | | | |
| GS 10 sec, | 1 | 1 | 1 | 2 | 2.5 |
| lb/100 ft² | | | | | |
| GS 10 min, | 10 | 14 | 15 | 16 | 17 |
| lb/100 ft² | | | | | |

Table 10 shows the filtration characteristics of the mud with increasing grass concentration. It is observed that as the concentration is increased, the filtration properties of the muds are improved, and the percentage water reduction is achieved is 19% at 1.0 ppb concentration. Making filtration as the basis for optimization, it is recommended that 1.0 ppb be the best optimum concentration. Thus, it can be stated that powdered grass can be used as a filtration control agent for drilling fluids.

TABLE 10
Filtration characteristics at 35 micron particle size

| t, | ml of Filtrate collected | | | | |
|---|---|---|---|---|---|
| min | 0 ppb | 0.25 ppb | 0.5 ppb | 0.75 ppb | 1.0 ppb |
| 5 | 5.6 | 5.2 | 4.9 | 4 | 3.4 |
| 10 | 8.6 | 8 | 7.5 | 6.4 | 6 |
| 15 | 10.4 | 10 | 9.5 | 8.2 | 7.8 |
| 20 | 12.1 | 11.8 | 11.2 | 9.7 | 9.3 |
| 25 | 13.6 | 13.2 | 12.6 | 11.1 | 10.8 |
| 30 | 15 | 14.5 | 13.7 | 12.5 | 12.1 |

| | | | | |
|---|---|---|---|---|
| % Reduction in | 3.33 | 8.67 | 16.67 | 19.33 |
| Water Loss | | | | |

From Table 11, it is seen that the addition of grass into the drilling mud decreases the pH of the mud. This is another applicability of grass powder to perform as an alkalinity control agent for drilling fluids.

TABLE 11
pH of the mud at 35 microns

| Mud | 0 ppb | 0.25 ppb | 0.5 ppb | 0.75 ppb | 1.0 ppb |
|---|---|---|---|---|---|
| pH | 8.5 | 8.4 | 8.22 | 8.08 | 7.92 |

In a second embodiment, the environmentally safe filtration control agent for drilling fluids comprises date seed powder.

The fruit of the date palm tree is an important crop in the Middle Eastern countries and is composed of a fleshy pericarp and seed. The seed constitutes about 10 to 15% of the date fruit weight. The date seed is often considered as a byproduct of dates processing plants, which produce pitted dates, date syrups and date confectioneries. The production of date fruits throughout the world is estimated to be 6.9 million tons, from which 863 thousand tons of date seeds are extracted. About 18% of the world's total production of date fruits is contributed by Saudi Arabia and are used mainly for animal feeds, such as for camel, sheep, and even the poultry industry. Analysis of Saudi Arabian date seeds indicated that these contain high amounts of protein, crude fat, and fibers. It is also a proven fact that date seeds serve as a natural source of phenolic compounds and as an antioxidant. Recently, it was found that date palm seed extracts inhibited the corrosion of mild carbon steel in steel pipelines and performed better when corroded with hydrochloric acid than sulfuric acid.

X-ray fluorescence (XRF) analysis was conducted on the date seed sample, which revealed the elemental composition shown in Table 12.

TABLE 12
XRF Results -- Date Seeds

| Element | Atomic Number | Net Normal weight % |
|---|---|---|
| Potassium (K) | 19 | 37.34 |
| Calcium (Ca) | 20 | 29.69 |
| Iron (Fe) | 26 | 10.36 |
| Chlorine (Cl) | 17 | 7.80 |
| Silicon (Si) | 14 | 6.21 |
| Sulfur (S) | 16 | 4.41 |
| Phosphorous (P) | 15 | 3.79 |
| Manganese (MN) | 25 | 0.41 |

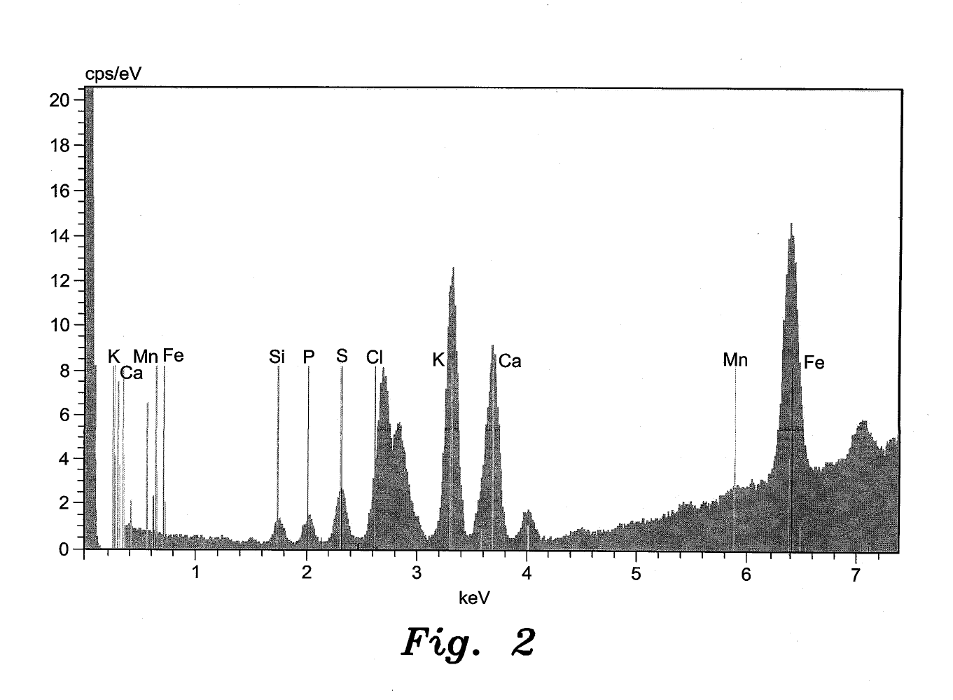

The XRF analysis showed that the date seeds sample consists of potassium, calcium, iron, chlorine, silicon, sulfur, phosphorous and manganese, with potassium contributing the highest weight percent in the sample. The graphical result of the XRF is shown in FIG. 2. The use of date seed powder as a filtration control agent for drilling fluids is illustrated by the following examples.

### Example 5

### Sample Preparation—Date Seed Powder

Date seeds were ground in a grinding machine. The powdered material was then passed through a series of U.S. Standard Series sieves of the fine series having a particle range in proportions shown in Table 13.

TABLE 13
Particle Size Distribution of Date Seed Sample

| Mesh | Sieve Size Opening | Percent Weight Retained |
|---|---|---|
| Number | (μ) | (%) |
| 30 | 600 | 19.72 |
| 50 | 300 | 62.40 |
| 100 | 150 | 15.74 |
| 120 | 125 | 1.96 |
| 200 | 75 | 0.17 |
| Over 200 | <75 | 0 |

A base mud is prepared using a commercially available viscosifier, bentonite. Bentonite is added to water under high speed stirring and different weights of date seed powder corresponding to different sieve sizes are added to this mixture. The rheological properties density, viscosity, filtration loss, pH concentration etc. of this newly developed drilling mud is then studied. Owing to the particle sizes selected, the inventors are of the opinion that date seed powder could be used as a fluid loss control additive and could be a potential replacement for toxic chemicals used in the oil industry.

### Example 6

### Characterization of Date Seed Powder—600 Micron Particle Size

This series of experiments is conducted on date seed powder having a particle size of 600 microns. It is evident from Table 14 that as the concentration of date seed powder in the drilling fluid increases, the rheology is modified. The apparent viscosity and the plastic viscosity increase, while the yield point increases and then comes back to its original value. The gel strength at 10 minutes is altered, gaining a maximum value of 15 lb/100 ft² at 1.0 ppb concentration. A good gel strength value indicates that the mud has cuttings carrying capacity. Thus, date seed powder can be used as a rheological modifier for drilling fluid applications.

TABLE 14
Rheological parameters at 600 micron
particle size - date seed powder

| | Dial Reading, | | | | |
|---|---|---|---|---|---|
| Speed, | 0 ppb (only | | | | |
| rpm | Bentonite) | 0.25 ppb | 0.5 ppb | 0.75 ppb | 1 ppb |
| 600 | 20 | 21 | 22 | 22.5 | 23 |
| 300 | 12 | 13 | 13.5 | 13.5 | 13.5 |
| 200 | 9 | 9.5 | 9.5 | 10 | 11 |
| 100 | 4 | 6.5 | 7 | 7.5 | 7.5 |
| 6 | 1.5 | 1.5 | 1.5 | 1.5 | 1.5 |
| 3 | 1 | 1.5 | 1.5 | 1.5 | 1.5 |
| AV, cp | 10 | 10.5 | 11 | 11.25 | 11.5 |
| PV, cp | 8 | 8 | 8.5 | 9 | 9.5 |
| YP, | 4 | 5 | 5 | 4.5 | 4 |
| lb/100 ft² | | | | | |
| GS 10 sec, | 1 | 1 | 1 | 1 | 1 |
| lb/100 ft² | | | | | |
| GS 10 min, | 10 | 12 | 13 | 14 | 15 |
| lb/100 ft² | | | | | |

Table 15 shows the filtration characteristics of the mud with increasing date seed powder concentration. It is observed that as the concentration is increased, the filtration properties of the muds are improved and the percentage water reduction achieved is about 13.33% at 1.0 ppb concentration. Making filtration as the basis for optimization, it is recommended that 0.75 ppb be the best optimum concentration. Thus, it can be stated that date seed powder can be used as s filtration control agent for drilling fluids.

TABLE 15
Filtration characteristics at 300 micron
particle size - Date Seed powder

| t, | ml of Filtrate collected | | | | |
|---|---|---|---|---|---|
| min | 0 ppb | 0.25 ppb | 0.5 ppb | 0.75 ppb | 1.0 ppb |
| 5 | 5.6 | 5.2 | 5 | 5 | 4.8 |
| 10 | 8.6 | 7.8 | 7.4 | 7 | 7 |
| 15 | 10.4 | 9.6 | 9.2 | 9 | 8.6 |
| 20 | 12.1 | 11.2 | 11 | 10.6 | 10.2 |
| 25 | 13.6 | 12.6 | 12.4 | 11.8 | 11.8 |
| 30 | 15 | 14 | 13.6 | 13 | 13 |

| | | | | |
|---|---|---|---|---|
| % Reduction in | 6.67 | 9.33 | 13.33 | 13.33 |
| Water Loss | | | | |

From Table 16, it is seen that the addition of date seed powder into the drilling mud decreases the pH of the mud. This is another applicability of date seed powder to perform as an alkalinity control agent for drilling fluids.

TABLE 16
pH of the mud at 600 microns

| Mud | 0 ppb | 0.25 ppb | 0.5 ppb | 0.75 ppb | 1.0 ppb |
|---|---|---|---|---|---|
| pH | 8.5 | 8.27 | 8.18 | 8.13 | 8.11 |

### Example 7

### Characterization of Date Seed Powder—300 Micron Particle Size

This series of experiments is conducted on date seed powder having a particle size of 300 microns. It is evident from Table 17 that as the concentration of date seed powder in the drilling fluid increases, the rheology is modified. The apparent viscosity and the plastic viscosity increase, while the yield point remains almost constant. The gel strength at 10 minutes is altered, gaining a maximum value of 16 lb/100 ft² at 2.0 ppb concentration. A good gel strength value indicates that the mud has cuttings carrying capacity. Thus, date seeds powder can be used as a rheological modifier for drilling fluid applications.

TABLE 17
Rheological parameters at 300 micron particle size

| | Dial Reading, | | | | |
|---|---|---|---|---|---|
| Speed, | 0 ppb (only | | | | |
| rpm | Bentonite) | 0.25 ppb | 1.0 ppb | 1.5 ppb | 2.0 ppb |
| 600 | 20 | 22 | 22 | 23 | 23 |
| 300 | 12 | 12.5 | 13 | 13.5 | 13.5 |
| 200 | 9 | 9.5 | 10 | 11 | 11.5 |
| 100 | 6 | 6.5 | 7 | 7.5 | 8 |
| 6 | 1.5 | 1.5 | 1.5 | 1.5 | 1.5 |
| 3 | 1 | 1.5 | 1.5 | 1.5 | 1.5 |
| AV, cp | 10 | 11 | 11 | 11.5 | 11.5 |
| PV, cp | 8 | 9.5 | 9 | 9.5 | 9.5 |
| YP, | 4 | 3 | 4 | 4 | 4 |
| lb/100 ft² | | | | | |
| GS 10 sec, | 1 | 1 | 1 | 1 | 2 |
| lb/100 ft² | | | | | |
| GS 10 min, | 10 | 12 | 13 | 14 | 16 |
| lb/100 ft² | | | | | |

Table 18 shows the filtration characteristics of the mud with increasing date seed powder concentration. It is observed that as the concentration is increased, the filtration properties of the muds are improved and the maximum percentage water reduction achieved is 20% at both 1.5 ppb and 2.0 ppb concentration. Making filtration as the basis for optimization, it is recommended that 1.5 ppb be the best optimum concentration. Thus, it can be stated that date seed powder can be used as a filtration control agent for drilling fluids.

TABLE 18
Filtration characteristics at 300 micron particle size

| t, | ml of Filtrate collected | | | | |
|---|---|---|---|---|---|
| min | 0 ppb | 0.25 ppb | 0.5 ppb | 0.75 ppb | 1.0 ppb |
| 5 | 5.6 | 5 | 4.8 | 4 | 3.9 |
| 10 | 8.6 | 7.9 | 7.8 | 6.2 | 6.2 |
| 15 | 10.4 | 9.9 | 9.8 | 7.9 | 7.8 |
| 20 | 12.1 | 11.5 | 11.4 | 9.4 | 9.2 |
| 25 | 13.6 | 12.9 | 12.8 | 10.7 | 10.4 |
| 30 | 15 | 14.2 | 14 | 11.8 | 11.5 |

| | | | | |
|---|---|---|---|---|
| % Reduction in | 5.33 | 6.67 | 21.33 | 23.33 |
| Water Loss | | | | |

From Table 19, it is seen that the addition of date seed powder into the drilling mud decreases the pH of the mud. This is another applicability of date seed powder to perform as an alkalinity control agent for drilling fluids.

TABLE 19
pH of the mud at 300 microns

| Mud | 0 ppb | 0.25 ppb | 0.5 ppb | 0.75 ppb | 1.0 ppb |
|---|---|---|---|---|---|
| pH | 8.5 | 8.22 | 7.9 | 7.76 | 7.57 |

### Example 8

### Characterization of Date Seed Powder—125 Micron Particle Size

This series of experiments is conducted on date seed powder having a particle size of 125 microns. It is evident from Table 20 that as the concentration of date seed powder in the drilling fluid increases, the rheology is modified. The apparent viscosity and the plastic viscosity increase, while the yield point remains almost constant, and then decreases at the last concentration. The gel strength at 10 minutes is altered, gaining a maximum value of 15 lb/100 ft² at 2.0 ppb concentration. A good gel strength value indicates that the mud has cuttings carrying capacity. Thus, date seeds can be used as a rheological modifier for drilling fluid applications.

TABLE 20
Rheological parameters at 125 micron particle size

| | Dial Reading, | | | | |
|---|---|---|---|---|---|
| Speed, | 0 ppb (only | | | | |
| rpm | Bentonite) | 0.25 ppb | 1.0 ppb | 1.5 ppb | 2.0 ppb |
| 600 | 20 | 22 | 22 | 23 | 23.5 |
| 300 | 12 | 13 | 13 | 13.5 | 13.5 |
| 200 | 9 | 9.5 | 10 | 10.5 | 10.5 |
| 100 | 6 | 7 | 7 | 7 | 7 |
| 6 | 1.5 | 1.5 | 1.5 | 1.5 | 1.5 |
| 3 | 1 | 1.5 | 1.5 | 1.5 | 1.5 |
| AV, cp | 10 | 11 | 11 | 11.5 | 11.75 |
| PV, cp | 8 | 9 | 9 | 9.5 | 10 |
| YP, | 4 | 4 | 4 | 4 | 3.5 |
| lb/100 ft² | | | | | |
| GS 10 sec, | 1 | 1 | 1 | 2 | 2 |
| lb/100 ft² | | | | | |
| GS 10 min, | 10 | 12 | 12 | 13 | 15 |
| lb/100 ft² | | | | | |

Table 21 shows the filtration characteristics of the mud with increasing date seed powder concentration. It is observed that as the concentration is increased, the filtration properties of the muds are improved and the maximum percentage water reduction is achieved. This concentration is recorded as 12% at 2.0 ppb concentration. Making filtration as the basis for optimization, it is recommended that 2.0 ppb be the best optimum concentration. Thus, it can be stated that date seed powder can be used as a filtration control agent for drilling fluids.

TABLE 21
Filtration characteristics at 125 micron particle size

| | |
|---|---|
| t, | ml of Filtrate collected |

| min | 0 ppb | 0.25 ppb | 1.0 ppb | 1.5 ppb | 2.0 ppb |
|---|---|---|---|---|---|
| 5 | 5.6 | 5.6 | 5 | 4.8 | 4.7 |
| 10 | 8.6 | 8.5 | 7.5 | 7.4 | 7 |
| 15 | 10.4 | 10.4 | 9.6 | 9.4 | 9 |
| 20 | 12.1 | 12 | 11.2 | 11.2 | 10.5 |
| 25 | 13.6 | 13.4 | 12.8 | 12.4 | 12 |
| 30 | 15 | 14.8 | 14 | 13.6 | 13.2 |

| | | | | |
|---|---|---|---|---|
| % Reduction in | 1.33 | 6.67 | 9.33 | 12 |
| Water Loss | | | | |

From Table 22, it is seen that the addition of date seed powder into the drilling mud decreases the pH of the mud. This is another applicability of date seed powder to perform as an alkalinity control agent for drilling fluids.

TABLE 22
pH of the mud at 125 microns

| Mud | 0 ppb | 0.25 ppb | 0.5 ppb | 0.75 ppb | 1.0 ppb |
|---|---|---|---|---|---|
| pH | 8.5 | 8.11 | 7.85 | 7.78 | 7.71 |

The basis of obtaining the most optimum particle size is based on the filtration characteristics exhibited by the muds formulated with date seed powder. It is observed that the best filtration values are obtained from the 300 micron sample with a concentration of 1.5 ppb.

In a third embodiment, the environmentally safe filtration control agent for drilling fluids comprises grass ash powder. X-ray fluorescence (XRF) analysis was conducted on the powdered grass ash sample, which revealed the elemental composition shown in Table 23.

TABLE 23
XRF Results -- Grass Ash Powder

| Element | Atomic Number | Net Normal weight % |
|---|---|---|
| Silicon (Si) | 14 | 27.56 |
| Calcium (Ca) | 20 | 23.46 |
| Potassium (K) | 19 | 21.82 |
| Chlorine (Cl) | 17 | 15.51 |
| Magnesium (Mg) | 12 | 3.40 |
| Sulfur (S) | 16 | 2.99 |
| Iron (Fe) | 26 | 2.00 |
| Phosphorous (P) | 15 | 1.70 |
| Aluminum (Al) | 13 | 1.21 |
| Titanium (Ti) | 22 | 0.24 |
| Manganese (MN) | 25 | 0.09 |

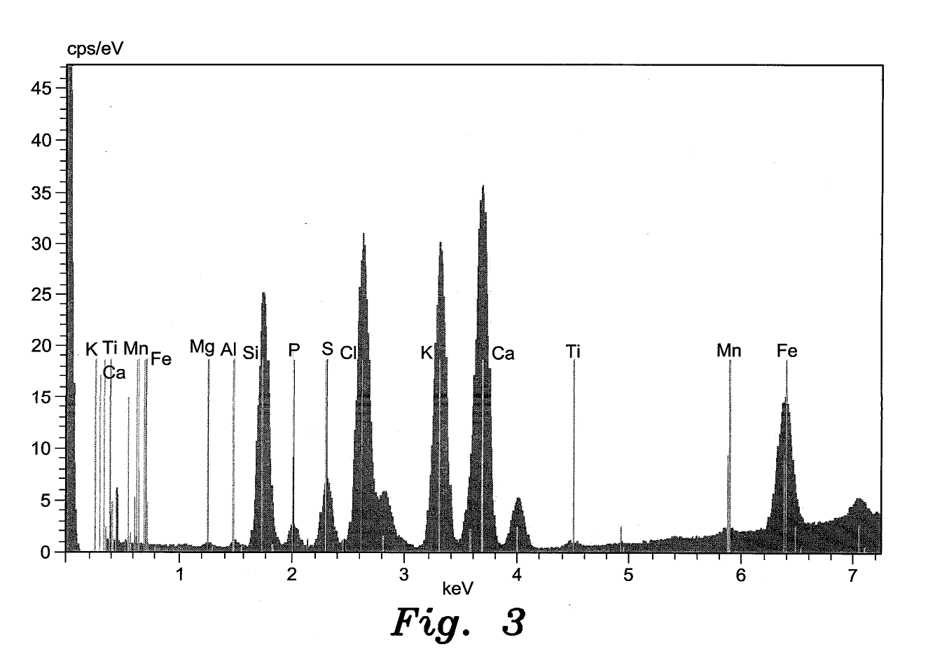

The XRF analysis showed that the grass ash sample consists of silicon, calcium, potassium, chlorine, magnesium, sulfur, iron, phosphorous, aluminum, titanium, and manganese, with silicon contributing the highest weight percent to the sample. The graphical result of the XRF is shown in FIG. 3. The use of grass ash powder as a filtration control agent for drilling fluids is illustrated by the following examples.

### Example 9

### Sample Preparation—Grass Ash Powder

Grass was dried in a sunny area for a week and then burnt in a furnace to obtain grass ash. The grass ash was then ground in a grinding machine. The powdered material was then passed through a series of U.S. Standard Series sieves of the fine series having a particle range in proportions shown in Table 2.

TABLE 24
Particle Size Distribution of Grass Ash Sample

| Mesh | Sieve Size Opening | Percent Weight Retained |
|---|---|---|
| Number | (μ) | (%) |
| 50 | 300 | 9.04 |
| 100 | 150 | 21.18 |
| 140 | 106 | 14.51 |
| 170 | 90 | 11.14 |
| 200 | 75 | 19.98 |
| Over 200 | >75 | 24.20 |

A base mud is prepared using a commercially available viscosifier, bentonite. Bentonite is added to water under high speed stirring and different weights of grass ash powder corresponding to different sieve sizes are added to this mixture. The rheological properties density, viscosity, filtration loss, pH concentration etc. of this newly developed drilling mud is then studied. Owing to the particle sizes selected, the inventors are of the opinion that grass ash powder could be used as a fluid loss control additive and could be a potential replacement for toxic chemicals used in the oil industry.

### Example 10

### Characterization of Grass Ash Powder—300 Micron Particle Size

This series of experiments is conducted on grass ash powder having a particle size of 300 microns. It is evident from Table 25 that as the concentration of grass ash powder in the drilling fluid increases, the rheology is modified. The apparent viscosity, plastic viscosity and yield point increases. The gel strength at 10 minutes is altered, gaining a maximum value of 19 lb/100 ft² at 1.0 ppb concentration. A good gel strength value indicates that the mud has cuttings carrying capacity. Thus, grass ash can be used as a rheological modifier for drilling fluid applications.

TABLE 25
Rheological parameters at 300 micron
particle size - grass ash powder

| | Dial Reading, | | | | |
|---|---|---|---|---|---|
| Speed, | 0 ppb (only | | | | |
| rpm | Bentonite) | 0.25 ppb | 0.5 ppb | 0.75 ppb | 1 ppb |
| 600 | 20 | 22 | 22 | 22.5 | 23.5 |
| 300 | 12 | 13.5 | 13.5 | 14 | 14.5 |
| 200 | 9 | 11 | 11 | 11 | 11.5 |
| 100 | 4 | 8 | 8 | 8 | 8.5 |
| 6 | 1.5 | 1.5 | 1.5 | 1.5 | 2.5 |
| 3 | 1 | 1.5 | 1.5 | 1.5 | 1.5 |
| AV, cp | 10 | 11 | 11 | 11.25 | 11.75 |
| PV, cp | 8 | 8.5 | 8.5 | 8.5 | 9 |
| YP, | 4 | 5 | 5 | 5.5 | 5.5 |
| lb/100 ft² | | | | | |
| GS 10 sec, | 1 | 2 | 3 | 3 | 4 |
| lb/100 ft² | | | | | |
| GS 10 min, | 10 | 17 | 18 | 18 | 19 |
| lb/100 ft² | | | | | |

Table 26 shows the filtration characteristics of the mud with increasing grass ash powder concentration. It is observed that as the concentration is increased, the filtration properties of the muds are improved and the percentage water reduction achieved is about 18.67% at 1.0 ppb concentration. Making filtration as the basis for optimization, it is recommended that 1.0 ppb be the best optimum concentration. Thus, it can be stated that grass ash powder can be used as s filtration control agent for drilling fluids.

TABLE 26
Filtration characteristics at 300 micron
particle size - Grass ash powder

| t, | ml of Filtrate collected | | | | |
|---|---|---|---|---|---|
| min | 0 ppb | 0.25 ppb | 0.5 ppb | 0.75 ppb | 1.0 ppb |
| 5 | 5.6 | 5.2 | 5.1 | 4.2 | 4 |
| 10 | 8.6 | 7.8 | 7.8 | 6.7 | 6.4 |
| 15 | 10.4 | 10 | 9.7 | 8.3 | 8.1 |
| 20 | 12.1 | 11.5 | 11.4 | 9.8 | 9.7 |
| 25 | 13.6 | 13 | 12.7 | 11.2 | 11 |
| 30 | 15 | 14.2 | 14 | 12.5 | 12.2 |

| | | | | |
|---|---|---|---|---|
| % Reduction in | 5.33 | 6.67 | 16.67 | 18.67 |
| Water Loss | | | | |

From Table 27, it is seen that the addition of grass ash powder into the drilling mud increases the pH of the mud. This is another applicability of grass ash powder to perform as an acidity control agent for drilling fluids.

TABLE 27
pH of the mud at 300 microns

| Mud | 0 ppb | 0.25 ppb | 0.5 ppb | 0.75 ppb | 1.0 ppb |
|---|---|---|---|---|---|
| pH | 8.5 | 8.5 | 8.58 | 8.66 | 8.73 |

### Example 11

### Characterization of Grass Ash Powder—90 Micron Particle Size

This series of experiments is conducted on grass ash powder having a particle size of 90 microns. It is evident from Table 6 that as the concentration of grass ash powder in the drilling fluid increases, the rheology is modified. The apparent viscosity and the plastic viscosity of the fluid increase, and the yield point also increases. The gel strength at 10 minutes is altered, gaining a maximum value of 24 lb/100 ft² at 1.0 ppb concentration. A good gel strength value indicates that the mud has cuttings carrying capacity. Thus, grass ash powder can be used as a rheological modifier for drilling fluid applications.

TABLE 28
Rheological parameters at 90 micron particle size

| | Dial Reading, | | | | |
|---|---|---|---|---|---|
| Speed, | 0 ppb (only | | | | |
| rpm | Bentonite) | 0.25 ppb | 0.5 ppb | 0.75 ppb | 1 ppb |
| 600 | 20 | 21 | 22 | 23 | 25 |
| 300 | 12 | 12.5 | 14.5 | 15 | 16.5 |
| 200 | 9 | 10.5 | 12.5 | 13 | 14 |
| 100 | 6 | 7.5 | 9 | 9.5 | 11 |
| 6 | 1.5 | 1.5 | 3 | 5 | 5.5 |
| 3 | 1 | 1.5 | 2.5 | 4.5 | 4.5 |
| AV, cp | 10 | 10.5 | 11 | 11.5 | 12.5 |
| PV, cp | 8 | 8.5 | 7.5 | 8 | 8.5 |
| YP, | 4 | 4 | 7 | 7 | 8 |
| lb/100 ft² | | | | | |
| GS 10 sec, | 1 | 3 | 6 | 8 | 9 |
| lb/100 ft² | | | | | |
| GS 10 min, | 10 | 17 | 20 | 21 | 24 |
| lb/100 ft² | | | | | |

Table 29 shows the filtration characteristics of the mud with increasing grass ash powder concentration. It is observed that as the concentration is increased, the filtration properties of the muds are improved, and the maximum percentage water reduction achieved greater than 20% at 1.0 ppb concentration. Making filtration as the basis for optimization, it is recommended that 1.0 ppb be the best optimum concentration. Thus, it can be stated that grass ash powder can be used as a filtration control agent for drilling fluids.

TABLE 29
Filtration characteristics at 90 micron particle size

| t, | ml of Filtrate collected | | | | |
|---|---|---|---|---|---|
| min | 0 ppb | 0.25 ppb | 0.5 ppb | 0.75 ppb | 1.0 ppb |
| 5 | 5.6 | 4.5 | 4.3 | 4.3 | 4.2 |
| 10 | 8.6 | 6.7 | 6.6 | 6.4 | 6.2 |
| 15 | 10.4 | 8.5 | 8.4 | 8.1 | 8 |
| 20 | 12.1 | 10 | 9.8 | 9.5 | 9.4 |
| 25 | 13.6 | 11.3 | 11.1 | 10.7 | 10.7 |
| 30 | 15 | 12.5 | 12.2 | 12 | 11.8 |

| | | | | |
|---|---|---|---|---|
| % Reduction in | 16.67 | 18.67 | 20 | 21.33 |
| Water Loss | | | | |

From Table 30, it is seen that the addition of grass ash powder into the drilling mud decreases the pH of the mud. This is another application of grass ash powder, to perform as an acidity control agent for drilling fluids.

TABLE 30
pH of the mud at 90 microns

| Mud | 0 ppb | 0.25 ppb | 0.5 ppb | 0.75 ppb | 1.0 ppb |
|---|---|---|---|---|---|
| pH | 8.5 | 8.7 | 9.17 | 9.29 | 9.36 |

### Example 12

### Characterization of Grass Ash Powder—26 Micron Particle Size

This series of experiments is conducted on powdered grass ash having a particle size of 26 microns. It is evident from Table 31 that as the concentration of grass ash powder in the drilling fluid increases, the rheology is modified. The apparent viscosity, plastic viscosity and yield point increases. The gel strength at 10 minutes is altered, gaining a maximum value of 28 lb/100 ft² at 1.0 ppb concentration. A good gel strength value indicates that the mud has cuttings carrying capacity. Thus, grass ash powder can be used as a rheological modifier for drilling fluid applications.

TABLE 31
Rheological parameters at 26 micron particle size

| | Dial Reading, | | | | |
|---|---|---|---|---|---|
| Speed, | 0 ppb (only | | | | |
| rpm | Bentonite) | 0.25 ppb | 0.5 ppb | 0.75 ppb | 1 ppb |
| 600 | 20 | 21 | 22 | 24 | 25.5 |
| 300 | 12 | 13.5 | 14.5 | 16 | 17 |
| 200 | 9 | 10.5 | 11.5 | 12.5 | 15 |
| 100 | 6 | 7.5 | 8.5 | 10 | 11.5 |
| 6 | 1.5 | 2.5 | 3.5 | 5.5 | 6.5 |
| 3 | 1 | 2 | 3 | 5 | 6 |
| AV, cp | 10 | 10.5 | 11 | 12 | 12.75 |
| PV, cp | 8 | 7.5 | 7.5 | 8 | 8.5 |
| YP, | 4 | 6 | 7 | 8 | 8.5 |
| lb/100 ft² | | | | | |
| GS 10 sec, | 1 | 4 | 6 | 8 | 9 |
| lb/100 ft² | | | | | |
| GS 10 min, | 10 | 18 | 19 | 24 | 28 |
| lb/100 ft² | | | | | |

Table 32 shows the filtration characteristics of the mud with increasing grass ash powder concentration. It is observed that as the concentration is increased, the filtration properties of the muds are improved, and the maximum percentage water reduction is achieved is 20.67% at 1.0 ppb concentration. Making filtration as the basis for optimization, it is recommended that 1.0 ppb be the best optimum concentration. Thus, it can be stated that grass ash powder can be used as a filtration control agent for drilling fluids.

TABLE 32
Filtration characteristics at 35 micron particle size

| t, | ml of Filtrate collected | | | | |
|---|---|---|---|---|---|
| min | 0 ppb | 0.25 ppb | 0.5 ppb | 0.75 ppb | 1.0 ppb |
| 5 | 5.6 | 4.52 | 4.3 | 4.2 | 4 |
| 10 | 8.6 | 6.7 | 6.6 | 6.5 | 6.3 |
| 15 | 10.4 | 8.4 | 8.3 | 8.2 | 8.1 |
| 20 | 12.1 | 9.9 | 9.8 | 9.7 | 9.5 |
| 25 | 13.6 | 11.2 | 11.1 | 11 | 10.7 |
| 30 | 15 | 12.4 | 12.3 | 12.2 | 11.9 |

| | | | | |
|---|---|---|---|---|
| % Reduction in | 17.33 | 18 | 18.67 | 20.67 |
| Water Loss | | | | |

From Table 33, it is seen that the addition of grass ash powder into the drilling mud increases the pH of the mud. This is another application of grass ash powder, to perform as an acidity control agent for drilling fluids.

TABLE 33
pH of the mud at 35 microns

| Mud | 0 ppb | 0.25 ppb | 0.5 ppb | 0.75 ppb | 1.0 ppb |
|---|---|---|---|---|---|
| pH | 8.5 | 8.74 | 9.18 | 9.38 | 9.44 |

The basis of obtaining the most optimum particle size is based on the filtration characteristics exhibited by the muds formulated with grass ash powder. It is observed that the best filtration values are obtained from the 90 micron sample with a concentration of 1.0 ppb.

It is to be understood that the present invention is not limited to the embodiments described above, but encompasses any and all embodiments within the scope of the following claims.

We claim:

1. An environmentally safe filtration control agent for drilling fluids, comprising an additive for drilling fluids selected from the group consisting of powdered grass, date seed powder, and grass ash powder.

2. The environmentally safe filtration control agent according to claim 1, wherein the additive is powdered grass comprising dried grass ground to a particle size between 300 microns and 35 microns.

3. The environmentally safe filtration control agent according to claim 2, wherein the drilling fluid is aqueous and the powdered grass is added to the drilling fluid to a concentration between 0.25 ppb and 1 ppb.

4. The environmentally safe filtration control agent according to claim 2, wherein the drilling fluid is aqueous and the powdered grass is added to the drilling fluid to a concentration of 1 ppb.

5. The environmentally safe filtration control agent according to claim 1, wherein the additive is date seed powder comprising date seeds ground to a particle size between 600 microns and 125 microns.

6. The environmentally safe filtration control agent according to claim 5, wherein the drilling fluid is aqueous and the date seed powder is added to the drilling fluid to a concentration between 0.25 ppb and 2.0 ppb.

7. The environmentally safe filtration control agent according to claim 5, wherein the drilling fluid is aqueous, the date seed powder has a particle size of 600 microns, and the date seed powder is added to the drilling fluid to a concentration of 0.75 ppb.

8. The environmentally safe filtration control agent according to claim 5, wherein the drilling fluid is aqueous, the date seed powder has a particle size of 300 microns, and the date seed powder is added to the drilling fluid to a concentration of 1.5 ppb.

9. The environmentally safe filtration control agent according to claim 5, wherein the drilling fluid is aqueous, the date seed powder has a particle size of 125 microns, and the date seed powder is added to the drilling fluid to a concentration of 2.0 ppb.

10. The environmentally safe filtration control agent according to claim 1, wherein the additive is grass ash powder comprising dried grass burnt in a furnace and ground to a particle size between 300 microns and 26 microns.

11. The environmentally safe filtration control agent according to claim 10, wherein the drilling fluid is aqueous and the grass ash powder is added to the drilling fluid to a concentration between 0.25 ppb and 1 ppb.

12. The environmentally safe filtration control agent according to claim 10, wherein the drilling fluid is aqueous, the grass ash powder has a particle size of 300 microns, and the grass ash powder is added to the drilling fluid to a concentration of 1.0 ppb.

13. The environmentally safe filtration control agent according to claim 10, wherein the drilling fluid is aqueous, the grass ash powder has a particle size of 90 microns, and the grass ash powder is added to the drilling fluid to a concentration of 1.0 ppb.

14. The environmentally safe filtration control agent according to claim 10, wherein the drilling fluid is aqueous, the grass ash powder has a particle size of 26 microns, and the grass ash powder is added to the drilling fluid to a concentration of 1.0 ppb.

15. A drilling fluid, comprising a mixture of:
bentonite;
water; and
a filtration control agent selected from the group consisting of powdered grass, date seed powder, and grass ash powder.

16. The drilling fluid according to claim 15, wherein said filtration control agent comprises powdered grass having a particle size between 300 microns and 35 microns, said filtration control agent having a concentration between 0.25 ppb and 1 ppb.

17. The drilling fluid according to claim 15, wherein said filtration control agent comprises date seed powder having a particle size between 600 microns and 125 microns, said filtration control agent having a concentration between 0.25 ppb and 2.0 ppb.

18. The drilling fluid according to claim 15, wherein said filtration control agent comprises date seed powder having a particle size of 300 microns, said filtration control agent having a concentration of 1.5 ppb.

19. The drilling fluid according to claim 15, wherein said filtration control agent comprises grass ash powder having a particle size between 300 microns and 26 microns, said filtration control agent having a concentration between 0.25 ppb and 1 ppb.

20. The drilling fluid according to claim 15, wherein said filtration control agent comprises grass ash powder having a particle size of 90 microns, said filtration control agent having a concentration of 1.0 ppb.
